(19) United States
(12) Patent Application Publication
(10) Pub. No.: US 2007/0096556 A1
(43) Pub. Date: May 3, 2007

(54) Automatic braking apparatus for a vehicle

(76) Inventors: Koichi Kokubo, Nagoya city (JP); Yukio Mori, Kariya city (JP)

Correspondence Address: BUCHANAN, INGERSOLL & ROONEY PC, POST OFFICE BOX 1404, ALEXANDRIA, VA, 22313-1404, US

(21) Appl. No.: 11/525,094

(22) Filed: Sep. 22, 2006

(30) Foreign Application Priority Data
Oct. 28, 2005 (JP) 2005-314153

(51) Int. Cl. B60T 8/60

(52) U.S. Cl. 303/155

(57) ABSTRACT

A torque applying device is provided for applying a driving torque to at least a pair of wheels, and a torque restraining device is provided for restraining the torque created on the wheels to be applied with the torque by the torque applying device. A friction braking device is provided for applying a braking torque to each wheel in response to operation of a brake pedal. An automatic braking control device automatically actuates the friction braking device independently of operation of the brake pedal, to apply the braking torque to each wheel. And, a torque restraining control device is provided for controlling the torque restrained by the torque restraining device to be maintained within a predetermined range, when the braking torque begins to be applied by the friction braking device, after the braking torque was applied by the automatic braking control device.

This application claims priority under 35 U.S.C. Sec. 119 to No.2005-314153 filed in Japan on Oct. 28, 2005, the entire content of which is herein incorporated by reference.

### BACKGROUND

The present invention relates to an automatic braking apparatus provided with an automatic braking control device for automatically actuating a friction braking device independently of a manually operated braking member, to apply a braking torque to each wheel, and particularly relates to the apparatus for performing the automatic braking control by the friction brake, when a restraining torque is being applied to the wheel with an engine brake, for example.

Recent vehicles are required to perform an automatic braking control, which is adapted to measure a distance from a vehicle to another vehicle ahead thereof or a difference between vehicle speeds of them, and adapted to perform a braking operation automatically to reduce the vehicle speed, if it is required to reduce the vehicle speed, and unless the vehicle driver is accelerating the vehicle, and which may be called as an adaptive cruise control (abbreviated as ACC). Now, control apparatuses for enabling the automatic braking control are getting popular.

For example, in Japanese Patent Laid-open Publication No.11-268558, there is disclosed as a prior art, a braking and driving force control apparatus for measuring a distance between a vehicle and another vehicle ahead thereof, and controlling a vehicle speed, or braking and driving force, so as to maintain the distance to be of an appropriate value. Then, in order to improve a ride comfort of the vehicle and realize the braking and driving force control with a good responsibility in overall vehicle speed range, proposed is the braking and driving force control apparatus for controlling axle torque of driving wheels of a traveling control apparatus provided for controlling a distance between the vehicles, or controlling the braking and driving force. With respect to this apparatus, it is described that an engine torque command value is calculated in accordance with a braking and driving force command value, and a throttle opening command value for a throttle actuator is calculated on the basis of the engine torque command value and the number of rotations of the engine. Next, a lower limit value for the throttle opening command value is calculated to be variable in accordance with the vehicle traveling state, and the throttle opening is limited in accordance with the lower limit value. Next, based on the lower limit value for the throttle opening command value and the number of rotations of the engine, the engine torque is calculated, and modified value of the braking and driving force is calculated in accordance with the lower limit value of engine torque. Then, as it is so constituted that the command value of the braking and driving force and the modified value of the braking and driving force are input, to calculate amount of operation of a brake actuator, it is described that the lower limit of the throttle opening can be set in accordance with the vehicle traveling state.

According to the braking and driving force control apparatus as described in the Publication, it is aimed to obtain a desired deceleration, with the engine brake and friction brake being controlled coordinately. In this case, if the engine torque is varied, for example, a delay will be caused to reflect it to vehicle deceleration. However, it is difficult to compensate the delay with the friction brake. As for the torque to be transmitted from the power train including the engine to the wheels (driving wheels), there are a driving torque provided by the power train, and a torque provided by the engine brake or the like for acting in a restraining direction opposite to the driving direction, which is called hereinafter as restraining torque. However, it is difficult to estimate accurately the restraining torque. Therefore, it is very difficult to control the braking torque, which is provided for reducing the torque created on the wheel by the friction brake and the restraining torque as described above, coordinately. Yet, it is extremely difficult to do so only by the friction brake.

With respect to the torque applied to the wheels (driving wheels), the restraining torque corresponds to the torque provided in the direction for preventing the wheels from being rotated, as well as the braking torque. Therefore, both of the restraining torque and the braking torque result in the braking force. In this application, however, they are distinguished from each other, so as to identify their origins.

### SUMMARY

Accordingly, it is an object of the present invention to provide an automatic braking apparatus for a vehicle, which is capable of obtaining a smooth brake feeling, even if an automatic braking control by a friction brake is performed, when a restraining torque is being applied to a wheel, with an engine brake, for example.

In accomplishing the above and other objects, the automatic braking apparatus comprises a torque applying device for applying a driving torque to at least a pair of wheels of the vehicle, a torque restraining device for restraining the torque created on the wheels to be applied with the torque by the torque applying device, a friction braking device for applying a braking torque to each wheel of the vehicle in response to operation of a manually operated braking member by a vehicle driver, and an automatic braking control device for automatically actuating the friction braking device independently of operation of the manually operated braking member, to apply the braking torque to each wheel of the vehicle. And, a torque restraining control device is provided for controlling the torque restrained by the torque restraining device, to be maintained within the predetermined range, when the braking torque begins to be applied by the friction braking device, after the braking torque was applied by the automatic braking control device.

Preferably, the apparatus as described above may further comprise a continuously variable control device for continuously controlling the driving torque applied by the torque applying device and the restraining torque restrained by the torque restraining device, and the torque restraining control device is adapted to control the restraining torque restrained by the torque restraining device to be maintained within the predetermined range, with the continuously variable control device being actuated.

In the apparatus as described above, it is preferable that the torque applying device includes an engine for constituting a power train installed in the vehicle, and that the continuously variable control device includes a continuously variable shift control device for continuously controlling the driving torque applied by the engine to the wheels. The torque restraining control device is adapted to restrain the torque created on the wheels to be applied with the driving torque, with an engine brake provided by the engine, and the continuously variable control device is adapted to control the restraining torque restrained by the engine brake, to be maintained within the predetermined range, with the continuously variable shift control device being actuated.

Also, in the apparatus as described above, the automatic braking control device is preferably adapted to control the braking torque applied by the friction braking device to front wheels and rear wheels of the vehicle, with the restraining torque being restrained by the torque restraining device for the wheels to be applied with the driving torque, and with the braking torque being applied by the friction braking device to each wheel of the vehicle, so as to be equal to a distribution of braking force to be applied to the front wheels and rear wheels of the vehicle.

Furthermore, when the distribution of the braking torque applied by the friction braking device to the front wheels and rear wheels is controlled, the braking torque applied to the wheels to be applied with the driving torque may be deducted by the amount of the restraining torque restrained by the torque restraining device.

Preferably, the apparatus may further comprise a radar device for detecting a state in front of the vehicle, and therefore, in response to the state detected by the radar device. And, the restraining torque restrained by the torque restraining device may be applied to the wheels to be applied with the driving torque, and the braking torque applied by the automatic braking control device may be applied to each wheel of the vehicle.

### BRIEF DESCRIPTION OF THE DRAWINGS

The above stated object and following description will become readily apparent with reference to the accompanying drawings, wherein like referenced numerals denote like elements, and in which:

FIG. 1 is a schematic block diagram of an automatic braking apparatus according to an embodiment of the present invention;

FIG. 2 is a schematic block diagram of a vehicle having an automatic braking apparatus according to an embodiment of the present invention;

FIG. 3 is a flow chart showing an automatic braking control performed by a friction brake, according to an embodiment of the present invention;

FIG. 4 is a time chart showing an automatic braking control performed by a friction brake, according to an embodiment of the present invention; and

FIG. 5 is a block diagram showing a hydraulic brake system according to an embodiment of the present invention.

### DETAILED DESCRIPTION OF EMBODIMENT

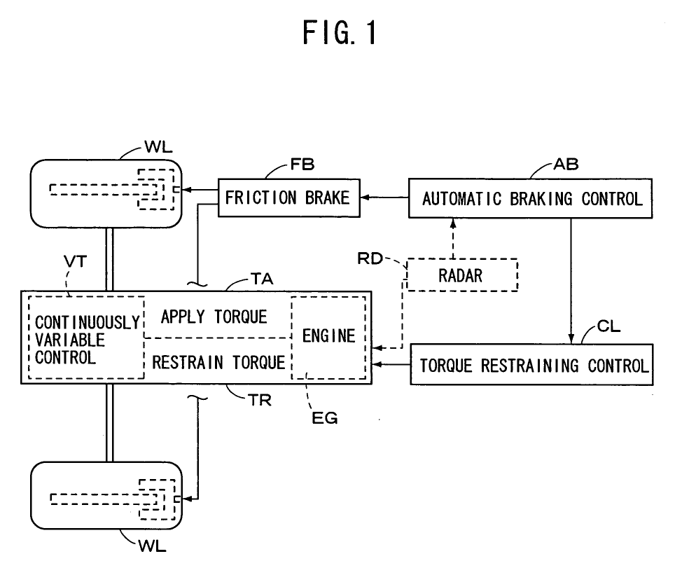

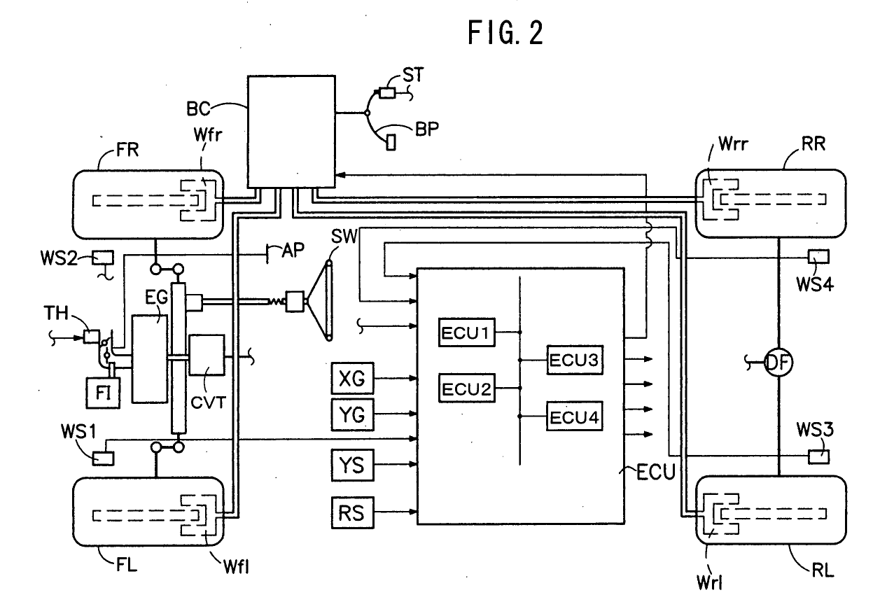

Referring to FIG. 1, there is schematically illustrated an automatic braking apparatus for a vehicle, according to an embodiment of the present invention. According to the present embodiment, the apparatus is provided with a torque applying device TA for applying a driving torque to at least a pair of wheels WL, WL of the vehicle, a torque restraining device TR for restraining the torque created on the wheels WL, WL to be applied with the torque by the torque applying device TA, a friction braking device FB for applying a braking torque to each wheel WL in response to operation of a manually operated braking member, which includes a brake pedal BP as shown in FIG. 2, and an automatic braking control device AB for automatically actuating the friction braking device FB independently of the manually operated braking member, to apply the braking torque to each wheel WL. And, a torque restraining control device CL is provided for controlling the torque restrained by the torque restraining device TR, to be maintained within a predetermined range, when the braking torque begins to be applied by the friction braking device FB, after the braking torque was applied by the automatic braking control device AB.

Furthermore, as indicated by a broken line in FIG. 1, a continuously variable control device VT may be provided for continuously controlling the driving torque applied by the torque applying device TA and the restraining torque restrained by the torque restraining device TR in a continuously variable (step less) manner. And, it may be so constituted that the torque restraining control device CL controls the restraining torque restrained by the torque restraining device TR, to be maintained within the predetermined range, with the continuously variable control device VT being actuated. The torque applying device TA includes an engine EG which constitutes a power train (not shown) installed in the vehicle. And, the continuously variable control device VT includes a continuously variable shift control device, e.g., continuously variable transmission (CVT), for controlling the driving torque applied by the engine EG to the wheels WL, WL in the continuously variable manner.

In this case, the torque restraining device TR is adapted to restrain the torque created on the wheels WL, WL, according to the engine brake provided by the engine, and the torque restraining control device CL adapted to maintain the restraining torque restrained by the engine brake within the predetermined range by the continuously variable shift control device. For example, the engine brake may be maintained within the predetermined range, with a gear ratio of the continuously variable transmission CVT being shifted into a lower gear ratio gradually. In addition, a throttle opening control or ignition timing control may be used at the same time. As for the torque restraining device TR, a so-called retarder may be used. Furthermore, it may be controlled by a motor control for a hybrid vehicle. In the present embodiment, the driving torque and braking torque applied to each wheel of the wheels WL, WL is to be controlled, whereas the torque applied to an axle for connecting those wheels WL, WL may be controlled, to represent both of the wheels. The latter feature is included in the present invention, as a matter of course. Furthermore, if a radar device RD for detecting a state in front of the vehicle, to detect a distance between the vehicles, it is so constituted that in response to the state detected by the radar device RD, the restraining torque restrained by the torque restraining device TR is applied to the wheels WL, WL to be applied with the driving torque, and the braking torque applied by the automatic braking control device is applied to each wheel WL.

Referring to FIG. 2, there is schematically illustrated an overall structure of a vehicle with the automatic braking apparatus according to an embodiment of the present invention. First of all, a power train system of the present embodiment includes an engine EG provided with a fuel injection apparatus FI and a throttle control apparatus TH which is adapted to control a throttle opening in response to operation of an accelerator pedal AP. Also, the throttle opening of the throttle control apparatus TH is controlled and the fuel injection apparatus FI is actuated to control the fuel injected into the engine EG, in response to output of the electronic control unit ECU. According to the present embodiment, the engine EG is operatively connected with the rear wheels RL and RR through the continuously variable transmission CVT and a differential gear apparatus DF. Thus, a so-called rear drive system is constituted in FIG. 2, while the drive system is not limited to the rear drive system, but the present invention is applicable to a front drive system or a four-wheel drive system.

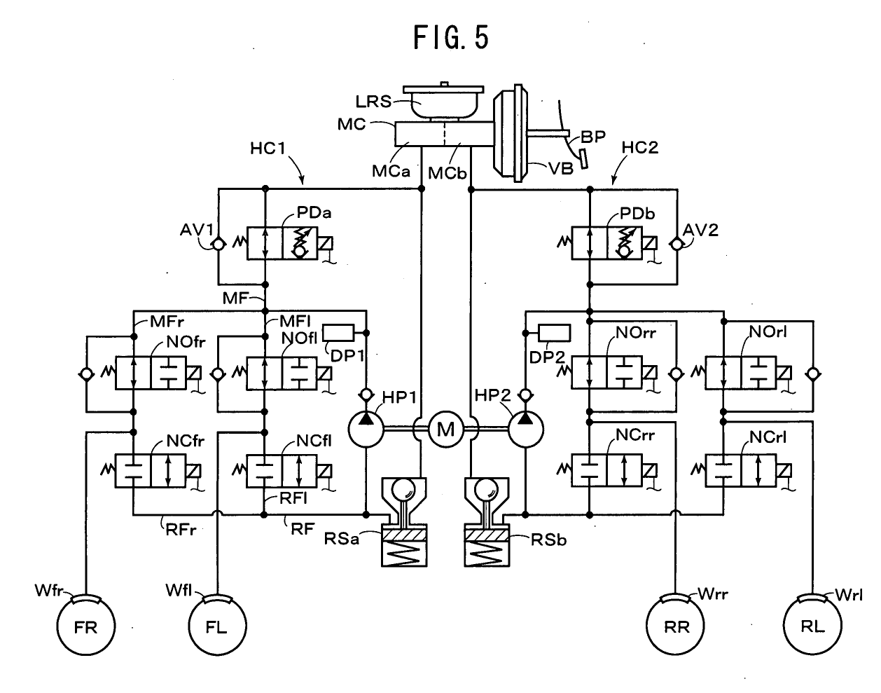

Next, in a brake system of the present embodiment, wheels FL, FR, RL and RR are operatively associated with wheel brake cylinders Wfl, Wfr, Wrl and Wrr, respectively, to which a hydraulic brake control apparatus BC is connected. In FIG. 2, a wheel FL designates the wheel at the front left side as viewed from the position of a driver's seat, a wheel FR designates the wheel at the front right side, a wheel RL designates the wheel at the rear left side, and a wheel RR designates the wheel at the rear right side. The hydraulic brake control apparatus BC includes a plurality of electromagnetic valves and an automatic hydraulic pressure source such as a hydraulic pressure pump, to provide a hydraulic pressure circuit capable of pressurizing brake fluid automatically. The apparatus BC is the same as a conventional apparatus in the prior art, as will be described later with reference to FIG. 5. With respect to the steering system, an electric power steering system (EPS) is used in the present embodiment, which does not relate directly to the present invention, and therefore explanation of which is omitted herein.

As shown in FIG. 2, in the vicinity of the wheels FL, FR, RL and RR, there are provided wheel speed sensors WS1-WS4, respectively, which are connected to the electronic control unit ECU, and by which a signal having pulses proportional to a rotational speed of each wheel, i.e., a wheel speed signal is fed to the electronic control unit ECU. There are also provided a stop switch ST which turns on when the brake pedal BP is depressed, a longitudinal acceleration sensor XG for detecting a vehicle longitudinal acceleration Gx (hereinafter, the longitudinal deceleration is indicated by “Gb”), which serves as the aforementioned deceleration detection device GD, a lateral acceleration sensor YG for detecting a vehicle lateral acceleration Gy, a yaw rate sensor YS for detecting a yaw rate γ of the vehicle and the like. These are electrically connected to the electronic control unit ECU. On the basis of those detected signals, the vehicle traveling state can be determined, according to the electronic control unit ECU. Furthermore, according to the present embodiment, a radar sensor RS is connected to the electronic control unit ECU, to be served as the radar device RD, and various devices including a laser radar and a millimeter wave radar (not shown) have been on the market.

In the electronic control unit ECU, the engine control system, braking control system, adaptive cruise control system and steering control system are connected with each other through a communication bus, so that each system may hold each information commonly. Among them, the engine control system includes a engine control unit ECU1 which is provided with CPU, ROM and RAM for calculating throttle opening, ignition timing, amount of fuel to be injected, and the like, and to which actuators (not shown) for controlling the throttle opening and the like are connected. The braking control system is adapted to perform the anti-skid control (ABS), traction control (TRC), vehicle stability control (VSC), automatic braking control (ACC) and the like, and includes a braking control unit ECU2 which is provided with CPU, ROM and RAM for the braking control to calculate various modified values as described later, and to which the wheel speed sensors WS, hydraulic pressure sensors (not shown), stop switch ST, yaw rate sensor YS, longitudinal acceleration sensor XG, lateral acceleration sensor YG and the like are connected. And, the braking control unit ECU2 is connected to the actuators (not shown).

Then, the adaptive cruise control system includes an adaptive cruise control unit ECU3, which is provided with CPU, ROM and RAM, and to which the radar sensor RS and the like are connected. The adaptive cruise control system is adapted to calculate the distance between the vehicles, relative speed to the vehicle traveling ahead, desired vehicle speed, desired deceleration and the like, and adapted to be capable of performing the automatic braking control thorough the braking control unit ECU2. Furthermore, the steering control system is connected to a steering control unit ECU4. These control units ECU1-4 are connected to the communication bus, through a communication unit (not shown) which is provided with CPU, ROM and RAM for communication, respectively. Therefore, the information required for each control system can be fed from other control systems.

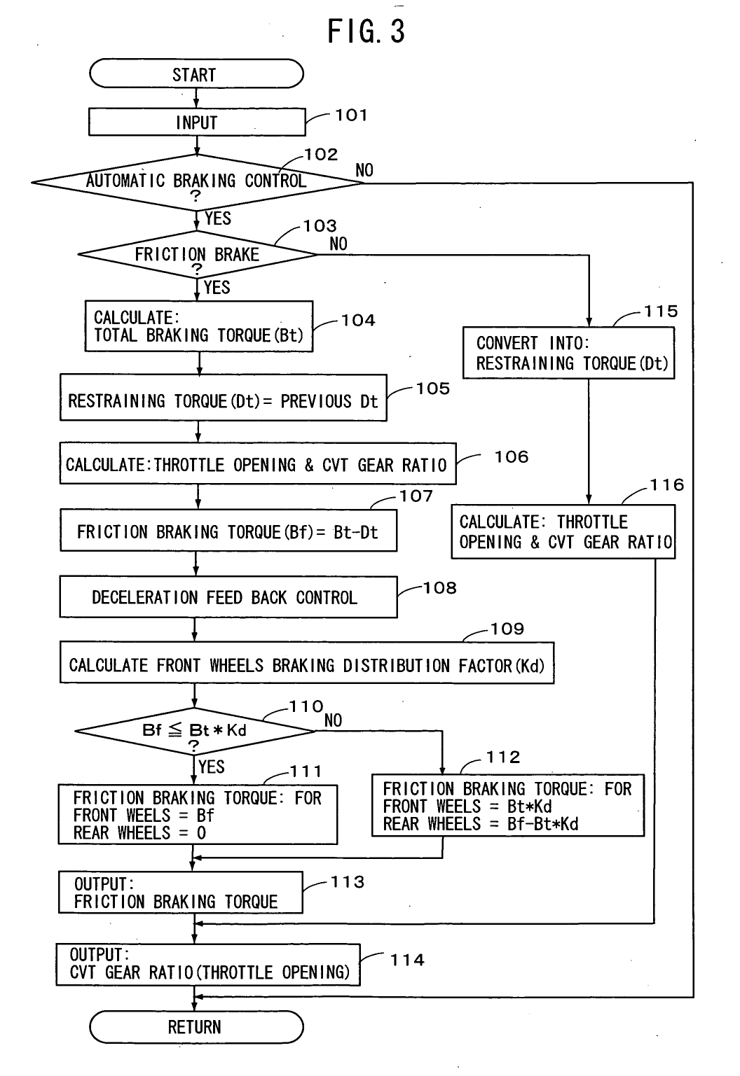

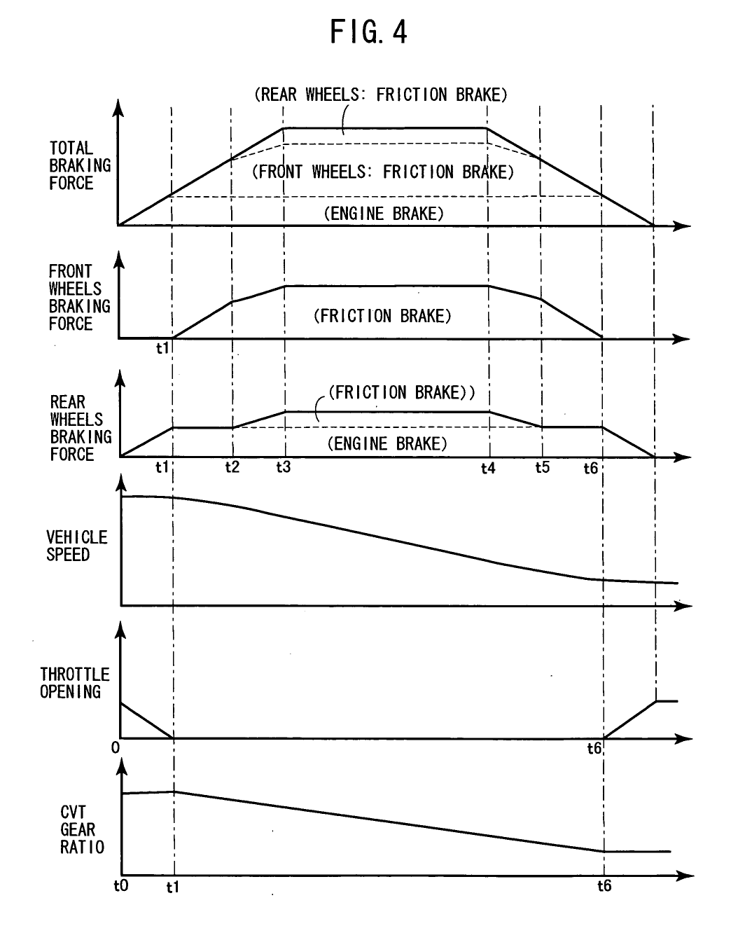

According to the vehicle as constituted above, a process for performing the automatic braking control, such as the aforementioned adaptive cruise control, will be explained referring to a flow chart as shown in FIG. 3 and a time chart as shown in FIG. 4. At the outset, the sensor signals are input at Step 101, and vehicle speed, longitudinal acceleration, lateral acceleration, yaw rate, distance between the vehicles or the like are read, and various data calculated by the control units ECU1-4 are read as well, through the communication signals. Next, at Step 102, it is determined whether the automatic braking control is being performed by the automatic braking control device AB. Unless the automatic braking control is being made, the program returns to a main routine (not shown). If the automatic braking control is being made by the throttle control, e.g., at the time “t0” in FIG. 4, the program proceeds to Step 103, where it is determined whether the braking torque is being applied by the friction braking device FB. If it is determined that the braking operation by the friction braking device FB is not being made, the program jumps to Step 115, where the braking operation will be made only by the engine brake. If the braking operation is being made by the friction braking device FB, e.g., at the period from “t1” and thereafter in FIG. 4, the program proceeds to Steps 104 and so on.

At Step 104, a total braking torque Bt is calculated on the basis of a desired deceleration provided for the automatic braking control. In other words, calculated is the total braking torque Bt, which is required for obtaining the desired deceleration at the time when the automatic braking control is made. Next, a restraining torque Dt caused by the engine brake is renewed, at Step 105, i.e., the restraining torque Dt at the previous cycle is provided for the present restraining torque Dt. For example, the torque restrained by the engine EG during the engine brake is multiplied by the gear ratio of the continuously variable transmission CVT, and further multiplied by the gear ratio of the differential gear DF, so that an axial torque of the axle of the driving wheels (rear wheels in the present embodiment) can be obtained. With the axial torque being distributed to each wheel, it can be obtained as the restraining torque for the rear wheels. Or, the axial torque may be used as it is, to provide two of the rear wheels for the wheels to be controlled. On the basis of the restraining torque Dt, the throttle opening is calculated (generally, set to be fully closed), and the gear ratio of the continuously variable transmission CVT is calculated, at Step 106.

Then, the program proceeds to Step 107, where a friction braking torque Bf to be applied by the friction braking device FB is calculated as the difference by subtracting the restraining torque Dt from the aforementioned total braking torque Bt, i.e., Bf=Bt−Dt. Accordingly, a deceleration feed back control to the braking torque Bf is performed for the automatic braking control, at Step 108. In this case, if a constant engine brake is always being produced, the driving wheel is likely to be locked at first on a road surface with low-coefficient of friction. Therefore, according to the braking force distribution control made by the friction braking device FB during the automatic braking control, it is preferable that the braking force applied to the driving wheels may be decreased a little, comparing with the conventional braking force distribution control. In this case, the decreased amount may be set to correspond to the braking force (restraining torque) caused by the engine brake and applied to the driving wheel. Accordingly, at the outset, a braking force distribution coefficient Kd (0<Kd<1) for the front wheels is calculated as Kd=0.7, for example. Next, at Step 110, the braking torque Bf obtained at Step 107 is compared with the product of multiplying the aforementioned total braking torque Bt by the braking force distribution coefficient Kd, i.e., Bt·Kd.

In the case where it is determined at Step 110 that the friction braking torque Bf is equal to or smaller than the calculated result (Bt·Kd), the program proceeds to Step 111, where the friction braking torque for the front wheels is set to be “Bf”, whereas the friction braking torque for the rear wheels, which correspond to the driving wheels in the present embodiment, is set to be zero, to provide such a state from the time “t1” to time “t2” as shown in FIG. 4, for example. On the contrary, when the friction braking torque Bf exceeds the calculated result (Bt·Kd), the program proceeds to Step 112, where the friction braking torque for the front wheels is set to be the calculated result (Bt·Kd), whereas the friction braking torque for the rear wheels is set to be a shortage to the friction braking torque Bf, i.e., (Bf−Bt·Kd), to provide such a state from the time “t2” to time “t3” as shown in FIG. 4, for example. Accordingly, the friction braking torque Bf is output at Step 113, and the gear ratio of the continuously variable transmission CVT is output at Step 114, then converted into a throttle opening (generally, to be shut off), if necessary. For example, the gear ratio of the continuously variable transmission CVT is controlled to be gradually shifted to lower gears, as shown. at the time “t1” and thereafter in FIG. 4, whereby the torque restrained by the engine brake is held at a predetermined value to be constant, and therefore maintained within the predetermined value.

On the other hand, if it is determined at Step 103 that the braking torque is not being applied by the friction braking device FB, the program proceeds to Step 115, where the desired deceleration provided for the automatic braking control is converted into the restraining torque Dt. Next, at Step 116, on the basis of the restraining torque Dt, the throttle opening and the gear ratio of the continuously variable transmission CVT are calculated, and the program proceeds to Step 114, where they are controlled, as shown at the time “t6” and thereafter in FIG. 4. At the time “t6” and thereafter, the friction brake can not be performed, whereas the engine brake is gradually decreased, according to a smooth transition, with the continuously variable transmission CVT being controlled.

Next, referring to FIG. 5, will be explained the hydraulic brake system including the hydraulic brake control apparatus BC as shown in FIG. 2, to be capable of being served as the friction braking device FB and automatic braking control device AB as shown in FIG. 1. According to this embodiment, a master cylinder MC of a tandem type is activated through a vacuum booster VB in response to depression of the brake pedal BP to pressurize the brake fluid in a low-pressure reservoir LRS and discharge the master cylinder pressure to the hydraulic circuits for the wheels FR and FL, and the wheels RR and RL, respectively. A first pressure chamber MCa of the master cylinder MC is communicated with a first hydraulic circuit HC1 for the wheels FR and FL, and a second pressure chamber MCb is communicated with a second hydraulic circuit HC2 for the wheels RR and RL, to form a front-rear dual circuit.

In the first hydraulic circuit HC1, the first pressure chamber MCa is communicated with wheel brake cylinders Wfr and Wfl, respectively, through a main hydraulic passage MF and its branch hydraulic passages MFr and MFl. In the main passage MF, there is disposed a proportional pressure difference valve PDa. This proportional pressure difference valve PDa is controlled by the electronic control unit ECU (braking control unit ECU2) to change its position between a communicating position and a pressure difference position, at the latter position of which a passage is narrowed in accordance with the pressure difference between the pressure at the side of the master cylinder MC and the pressure at the side of normally open valves NOfr and NOfl, to provide a desired pressure difference. In parallel with the proportional pressure difference valve PDa, there is disposed a check valve AV1 which allows the brake fluid in the master cylinder MC to flow to a downstream direction (toward the wheel brake cylinders Wfr and Wfl), and prevents its reverse flow. The check valve AV1 is provided for pressurizing the hydraulic pressure in the wheel brake cylinders Wfr and Wfl, when the brake pedal BP is depressed, even if the proportional pressure difference valve PDa is placed in its closed position.

The normally open valves NOfr and NOfl are disposed in the branch passages MFr and MFl, respectively. And, normally closed valves NCfr and NCfl are disposed in branch passages RFr and RF1, respectively, which merge into a drain passage RF connected to a reservoir RSa. In the first hydraulic circuit HC1 for the wheels FR and FL, a hydraulic pressure pump HP1 is disposed, with its outlet connected to the normally open valves NOfr and NOfl through a damper DPi, and with its inlet connected to the reservoir RSa. In the second hydraulic circuit HC2 for the wheels RR and RL, there are disposed a proportional pressure difference valve PDb, damper DP2, normally open valves NOrr and NOrl, normally closed valves NCrr and NCrl, and a check valve AV2. The hydraulic pressure pump HP2 is driven by an electric motor M together with the hydraulic pressure pump HP1, both of the pumps HP1 and HP2 will be driven continuously after the motor M begins to operate them.

Accordingly, the proportional pressure difference valve PDa (and PDb) is controlled by the electronic control unit ECU to change its position between a communicating position and a pressure difference position, at the latter position of which a passage is narrowed in accordance with the pressure difference between the pressure at the side of the master cylinder MC and the pressure at the side of normally open valves NOfr and NOfl, to provide a desired pressure difference. In this connection, the normally open valves NOfr and NOfl and the like act as a so-called cut-off valve. Therefore, the braking toque can be applied to the wheels FR and the like in response to operation of the brake pedal BP by the vehicle driver, and also the braking toque can be automatically applied to the wheels FR and the like independent of the brake pedal BP.

It should be apparent to one skilled in the art that the above-described embodiment is merely illustrative of but one of the many possible specific embodiments of the present invention. Numerous and various other arrangements can be readily devised by those skilled in the art without departing from the spirit and scope of the invention as defined in the following claims.

What is claimed is:

1. An automatic braking apparatus for a vehicle, comprising:
torque applying means for applying a driving torque to at least a pair of wheels of said vehicle;
torque restraining means for restraining the torque created on said wheels to be applied with the torque by said torque applying means;
friction braking means for applying a braking torque to each wheel of said vehicle in response to operation of a manually operated braking member by a vehicle driver;
automatic braking control means for automatically actuating said friction braking means independently of operation of said manually operated braking member, to apply the braking torque to each wheel of said vehicle; and
torque restraining control means for controlling the torque restrained by said torque restraining means, to be maintained within a predetermined range, when the braking torque begins to be applied by said friction braking means, after the braking torque was applied by said automatic braking control means.

2. An automatic braking apparatus as set forth in claim 1, further comprising continuously variable control means for continuously controlling the driving torque applied by said torque applying means and the restraining torque restrained by said torque restraining means, wherein said torque restraining control means controls the restraining torque restrained by said torque restraining means, to be maintained within the predetermined range, with said continuously variable control means being actuated.

3. An automatic braking apparatus as set forth in claim 2, wherein said torque applying means includes an engine for constituting a power train installed in said vehicle, and said continuously variable control means includes a continuously variable shift control device for continuously controlling the driving torque applied by said engine to said wheels, and wherein said torque restraining means restrains the torque created on said wheels to be applied with the driving torque, with an engine brake provided by said engine, and said torque restraining control means controls the restraining torque restrained by the engine brake, to be maintained within the predetermined range, with said continuously variable shift control device being actuated.

4. An automatic braking apparatus as set forth in claim 3, wherein said torque restraining control means controls a gear ratio of said continuously variable shift control device to maintain the restraining torque within the predetermined range.

5. An automatic braking apparatus as set forth in claim 1, wherein said automatic braking control means controls the braking torque applied by said friction braking means to front wheels and rear wheels of said vehicle, with the restraining torque being restrained by said torque restraining means for said wheels to be applied with the driving torque, and with being the braking torque applied by said friction braking means to each wheel of said vehicle, so as to be equal to a distribution of braking force to be applied to said front wheels and rear wheels of said vehicle.

6. An automatic braking apparatus as set forth in claim 5, wherein when the distribution of the braking torque applied by said friction braking means to said front wheels and rear wheels of said vehicle is controlled, the braking torque applied to said wheels to be applied with the driving torque is deducted by the amount of the restraining torque restrained by said torque restraining means.

7. An automatic braking apparatus as set forth in claim 1, further comprising radar means for detecting a state in front of said vehicle, wherein, in response to the state detected by said radar means, the restraining torque restrained by said torque restraining means is applied to said wheels to be applied with the driving torque, and the braking torque applied by said automatic braking control means is applied to each wheel of said vehicle.
